(19) United States
(12) Patent Application Publication
(10) Pub. No.: US 2016/0148136 A1
(43) Pub. Date: May 26, 2016

(54) MULTIPLE SEQUENTIAL PLANNING AND ALLOCATION OF TIME-DIVISIBLE RESOURCES

(71) Applicants: Boyi NI, Shanghai (CN); Hao WU, Beijing (CN); Wen-Syan LI, Shanghai (CN)

(72) Inventors: Boyi NI, Shanghai (CN); Hao WU, Beijing (CN); Wen-Syan LI, Shanghai (CN)

(21) Appl. No.: 14/551,099

(22) Filed: Nov. 24, 2014

(51) Int. Cl. G06Q 10/06

(52) U.S. Cl. CPC G06Q 10/06312; G06Q 10/06316

(57) ABSTRACT

A system and method provide optimized resource planning and allocation. Various constraints of each resource are factors of the overall optimization. In various implementations, one or more iterative algorithms are used in the optimization for efficient resource allocation.

### TECHNICAL FIELD

The present disclosure relates generally to a framework for resource planning and allocation.

### BACKGROUND

For a business project owning a large amount of time-divisible resources such as vehicles, equipment, or labor forces, the cost of resource consumption can be directly time dependent. The amount of resources is generally limited compared to the potential demands from different parties or locations. Therefore, efficient planning and allocation of all resources can be a natural desire.

One well established problem to explain the fundamental of multiple sequential resource planning and allocation is, probably, the multiple traveling salesman problem (mTSP). Generally, the original TSP poses the question of finding a closed path (i.e. a circuit in graph theory) to visit each depot exactly once. The main optimization goal is the minimization of the total journey distance all salesmen traverse. However, the original mTSP often generalizes many features that may make it less accurate for some applications.

For example, to optimize the arrangement and allocation of police patrols within a city, the original mTSP can be less efficient and/or inaccurate since the goals in that case may include other man-power or safety related constraints.

### SUMMARY

A framework for providing optimized resource planning and allocation is described herein. In accordance with one aspect, the framework receives location information regarding a plurality of resources and a plurality of users. The framework may then generate, based on the location information, a quantity of random travel routes for the plurality of resources to make contact with the plurality of users, select a percentage of the routes with a lowest cost and ordering the selected routes according to an increasing order of cost, and update a probability density function matrix with the selected routes based on the selecting and the ordering. Such steps may be repeating for a preselected number of iterations or until convergence to output a route with a lowest cost.

With these and other advantages and features that will become hereinafter apparent, further information may be obtained by reference to the following detailed description and appended claims, and to the figures attached hereto.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 is a block diagram of an example computing system environment, wherein at least a portion of the techniques and systems described herein may be applied.

FIG. 2 is a diagram of example multiple sequential planning and allocation of resources.

FIG. 3 is a map diagram showing an example patrol area, illustrating locations of police stations and event hot spots.

FIGS. 4A-B are exemplary tables of distance matrix, and weights of importance and minimum patrol visits for hotspots respectively.

FIG. 5 is a diagram of an example output of a system of multiple patrol route planning and allocation arrangement.

FIG. 6 is an example process for optimizing allocation of resources to users.

### DETAILED DESCRIPTION

Various techniques and systems for optimizing multiple resource planning and allocation are disclosed, according to example implementations. In various implementations, a resource allocation arrangement (RAA) uses multiple constraints of the resources as factors of the overall optimization. In an implementation, one or more algorithms are used to factor the constraints into the optimization, for efficient resource allocation.

In an implementation, the RAA includes the priority of each demand for resource, organized in a sequential order, such that the use right can be transferred from one party (e.g., user, site, client, event hotspot, etc.) to another. In an implementation, the RAA uses additional constraints for some resources such as a labor-force, for example, to include consideration for assigning equal burdens to be shared across the labor resource.

In various implementations, the RAA uses a modified cross entropy (CE) technique to optimize the allocation of resources. For example, in an implementation, the highest occupation time of the resource by the parties is an indicator of greatest efficiency (e.g., that the users are using the resource the most efficiently).

In an implementation, the RAA comprises a task planning and allocation system with well-designed logic. For example, in one embodiment, the RAA comprises a police patrol planning and allocation arrangement, arranged to provide optimized and efficient police service to desired portions of a city.

In various implementations, one or more of the following factors are considered and applied by the RAA to provide a solution for optimized resource planning and allocation. First, resources are in multiple portions, each of which is arbitrarily time divisible (continuous in time) and may have arbitrary lengths. Next, resource users are also in multiple groups, where both are possibly physically located in different places. In addition, the RAA may consider the cost of passing resources from one user to the other (where the resources are used by users in a time sequence), which depends, for example, on the distance between the two users, traffic conditions, etc. In some implementations, the RAA determines the optimal sequence of resource use. The number of resources/users may be adaptable. The RAA may append or remove part of the resources/users from the system at any time. Further, the cost functions may change with time; as such, the strategy used by the RAA is optimal to time-variant resource allocation problems (e.g., the resource demand may be variable, etc.). The RAA may also consider the equilibrium among the resource groups, that the “workload” for each group is generally equal (for instance, each shift of police patrol teams are equal in duration). In various implementations, this is achieved implicitly, since the solution from the RAA can be labeled to target a user and a time slot, which is already “allocated” to a specific user and time.

Various techniques for optimizing multiple resource planning and allocation are disclosed. The discussion herein is intended to illustrate components and techniques which may be utilized in optimizing multiple resource planning and allocation according to a variety of applications, but the examples described are not intended to be limiting. In various implementations, fewer, alternate, or additional components may be included to perform various portions of described techniques while remaining within the scope of the disclosure.

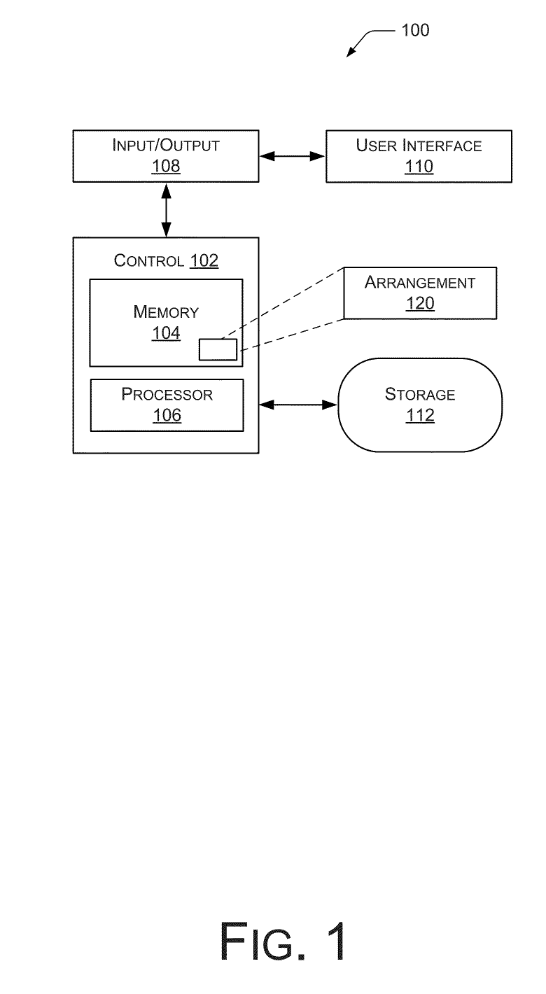

FIG. 1 shows an example of a system 100 wherein the techniques and devices discussed herein may be implemented. In the example, the system 100 uses a control module 102, for example, to perform computational, analytical, and control functions for the system 100. As shown in FIG. 1, the control module 102 may include a memory 104 and one or more processors 106, as are described further below. In various implementations, the system 100 includes an input/output (I/O) module 108, a user interface (UI) 110, and may also include a storage component 112.

In an implementation, the memory 104 comprises one or more types of hardware memory storage devices (fixed or portable), or the like. In the implementation, one or more inputs (such as geo-location information) are loaded into the memory 104 for access by the processor 106 while running an application. In an implementation, the application may also be stored in the form of computer-executable instructions within the memory 104. In various implementations, portions of the resource allocation arrangement (RAA) 120 are included in the application, and are executed as the application is run.

For example, in an implementation, the processor 106 performs optimized resource planning and allocation via one or more algorithms, as part of running the application, which include techniques for determining and optimizing resource allocation across all available resources via the RAA 120.

In an implementation, the input/output module 108 can receive locational data (e.g., location information, geo-location information, etc.) for one or more objects over durations of time. The durations may be hours, days, weeks, months, years, or the like. The locational data may be collected from a resource, for instance, particularly if the resource is mobile or portable, and/or a user (or event/use location, etc.). In an implementation, the locational data comprises spatial-temporal data, or the like. In one example, the locational data may comprise a timestamp and a location of a mobile resource, such as a police patrol officer, or the like.

In another example, the locational data includes global positioning satellite (GPS) data or signal triangulation information (e.g., radio frequency or other signal types, such as cellular, etc.) regarding the resource and/or user. In an implementation, the memory 104 collects and stores the locational data received by the input/output module 108. In an implementation, the control module 102 (using the processor 106) is arranged to use the locational data to optimize resource allocation (e.g., to determine distances from the resources to the users, to generate travel/patrol routes, etc.).

In an implementation, the storage 112 comprises one or more memory storage devices that are typically used for bulk data storage, and have a greater capacity as compared to the memory 104. A non-exhaustive list of storage 112 components includes hard disk drives, floppy disk drives, optical drives, tape drives, and the like.

In various implementations, the system 100 may be connected to a network. In alternate implementations, the network may include a network such as an Ethernet Local Area Network (LAN), a token ring LAN, or other LAN, a Wide Area Network (WAN), a system area network, or other type of network, and can include several nodes or hosts (not shown). Moreover, the network can also include hardwired, optical, and/or wireless connection paths. In various implementations, the storage 112 may be located remotely, and accessed via the network (e.g., remote server, cloud storage, etc.).

In alternate implementations, the system 100 may be comprised of fewer or additional components, within which differently arranged structures may perform the techniques discussed within the disclosure.

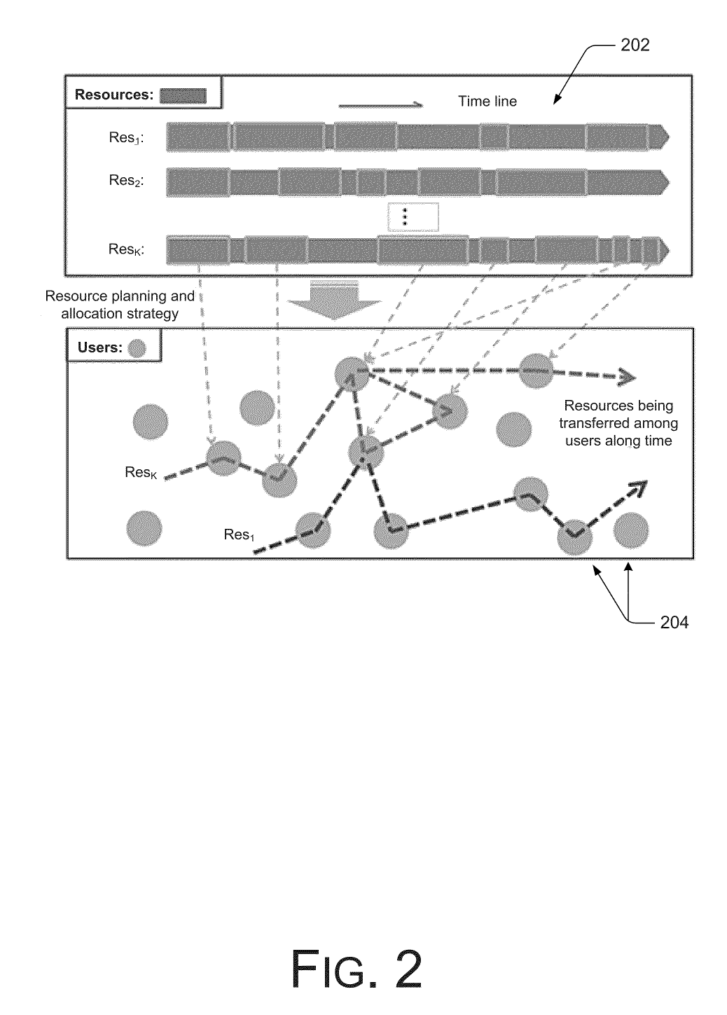

In an implementation, as illustrated in FIG. 2, resources 202 (Res₁, Res₂ . . . Resₖ) are divided into a number of groups, like labor forces, vehicles, CPU cores, etc. In the implementation, the cost of consuming these resources 202 by a user 204 is proportional to time, plus the transfer cost from the previous user 204. In various examples, the cost also includes other costs like basis cost for initialization/restart, etc. In the implementation, the resource cost for each time unit, as well as the transfer cost and the basis cost are known.

In an implementation, the RAA 120 is arranged to provide the best strategy (e.g., an optimized schedule) of planning and allocation of the multiple resources 202, so that the overall cost is minimized, during a time period [t₁, t₂], and according to the demand of multiple users 204 (which may also change from time to time). This can be formulated as: determine the best planning P*(t₁, t₂) from all possible schedules [symbol] (t₁, t₂) (here omitting (t₁, t₂) for simplicity):

$${cost}_{total} ( P ) = [ {cost}_{resource} ( P ) + {cost}_{transfer} ( P ) + {cost}_{basis} ( P ) + … ]$$

In an implementation, the RAA 120 is designed for large organizations. (e.g., a large police force, a delivery company with many vehicles and employees, or the like) such that an efficient or even a feasible solution are too complex to be solved manually. In an implementation, the system 100 is arranged to provide an optimized allocation of resources 202 by using numerical optimization methods, or the like, based on location information of the resources 202 and/or the users 204.

For example, a portion of a planning and allocation scenario can be transformed into a modified form of a multiple traveling salesmen problem (mTSP). In an implementation, the RAA 120 is arranged to provide a solution to the mTSP using a modified cross entropy (CE) technique. For mTSP that are combinatorial optimization problems, the RAA 120 employs a heuristic method, wherein the “NP hard” mTSP is formulated using one or more algorithms to fit different practical applications.

The examples described herein with respect to a system 100 and an RAA 120 are specific to a police patrol planning and allocation scenario, having one or more (or all) of the following features: Police officers (i.e., resources 202) are scheduled to make patrols to prevent street crimes to the maximum extent. Within an area, a number of crime hotspots (i.e., users 204) are scheduled to be patrolled, considering the importance of the hotspots, the road map, police force limits, and workload balances among teams.

However, the example of police patrols is not intended to be limiting. In other implementations, the system 100 and the RAA 120 may be arranged to plan and allocate other resources in other scenarios. In one example, it may be desirable for salesmen or delivery truck drivers to have the best routes to contact as many customers as possible. For instance, the quantities of latent customers may vary in different regions, so the costs to be paid for the visits to different regions may vary also (which also can depend on previous visits). In an implementation, the goal is maximizing the number of customers they can visit, considering the potential rewards (importance) of the customers, and meanwhile minimizing the costs. In one case, the salesmen may be members of a group, where they cooperate to accomplish a selling task together.

In another example, a shipping container leasing company desires to circulate its containers (i.e., resources 202) with a highest occupancy rate. In this example, the empty containers are shipped in advance to meet the demand at different places (i.e., users 204). The constraints of maximizing the occupancy rate can include the costs and availability of transportation for the containers, the seasonal demand change in different regions, the constraints of warehouse capacity, risk control, and other human interventions, and the like.

In other implementations, the system 100 may be applied to other scenarios, where it is desirable to sequentially allocate multiple resources 202 to multiple users 204. Additionally, the allocation of resources 202 in each scenario can include various constraints, including variant objectives, lowest traffic costs, capacity limits, maximum benefit, workload balance, and the like.

In an example, the system 100 may be employed to provide an optimized patrol route for a city's police force. As part of the optimization, the RAA 120 may consider the following constraints and variants: (1) multiple policemen; (2) multiple depots; (3) fixed charges; and (4) time windows. More particularly, the policemen can be multiple, either of a fixed number or bounded by a value, which results in a multiple traveling salesmen problem (mTSP). In addition, there may be multiple depots with a number of policemen setting off from each depot. A policeman can return to any depot, while the number of policemen at each depot can be fixed to be unchanged after all the travels are finished. Further, if the number of policemen is undetermined with an upper bound, then the usage of each policeman can have a fixed cost, with the total cost to be minimized. Even further, it can be desirable that certain event spots be visited in specific time periods (time windows). This may be the case for particular locations, which may have increased incidents of crime during some hours. (The addition of time windows makes the problem a mTSP with Time Windows (mTSPTW).)

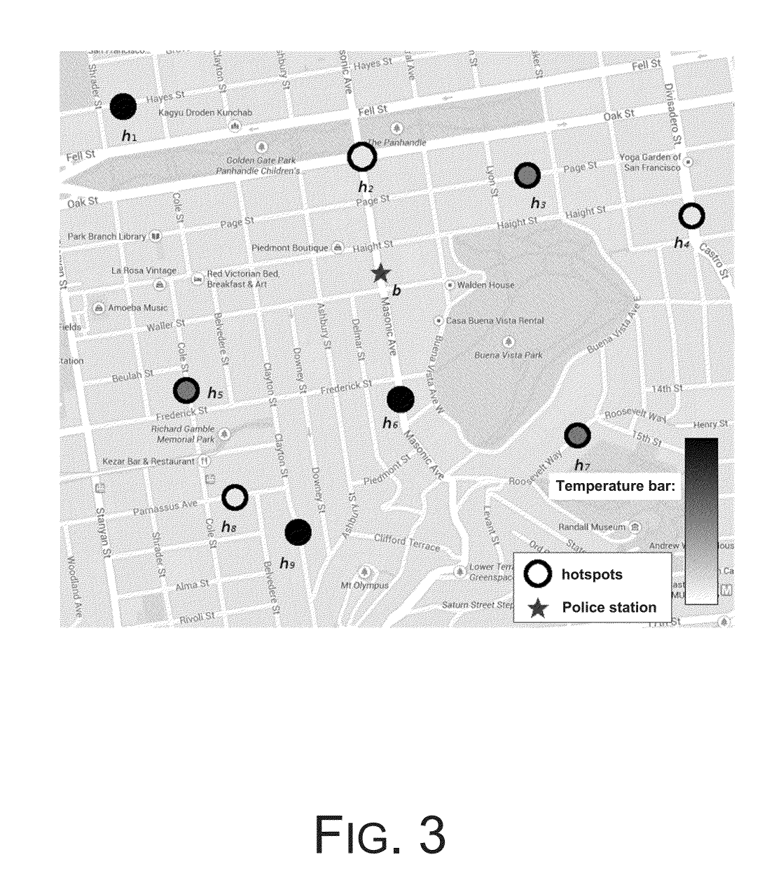

In an example, as shown in FIG. 3, the city police office takes responsibility for the public security of one or more of the areas of a city (e.g., the map shows the Buena Vista Park area in San Francisco as an example) and practices crime prevention. Typical crime prevention can include routinely patrolling a list of places called “hotspots,” which are locations (i.e., users 204) analyzed and extracted from a record database of crime occurrences. Hotspots (h₁ through h₉) are illustrated FIG. 3, along with their distance (shortest route) from each other (given in Table 1).

In an implementation, hotspots are identified and defined by exact geometrical location, with weight of importance. For example, the geo-location of various hotspots may be received by the input/output module 108, or the like. In one example, the geo-location of a hotspot may change, as the criminal activity moves to avoid constant observation, or the like. In such cases, the geo-location information received by the input/output module 108 may be updated regularly. For example, hotspots can usually appear near a railway station, a shopping mall, on a street near the front of a bar, etc.

In an embodiment, police officers (i.e., resources 202) are scheduled (e.g., travel/patrol routes are generated based on location information) by the system 100 to make visits to the hotspots as many times as possible, with a minimum quantity of visits for each hotspot. For example, the police officers may receive the schedule of hotspot visits from the system 100, in the form of one or more routes displayed on the map (or the like) shown in FIG. 3. The map may appear on the display of a mobile device, on a patrol car communication/computing device, or other display hardware accessible to the police officers. Further, the map may be updated on occasion when hotspot locations or scheduling assignments are adjusted. For instance, the map may be updated when the input/output module 108 receives updated hotspot geo-location information. (According to a criminological model from many studies, it can be shown that a patrol team visiting a hotspot for a minimum duration can suppress the incidence of crime near the hotspot.)

In an implementation, the RAA 120 considers ideal visit (or dwell) duration when scheduling resources. In the police patrol example, the ideal dwell duration may be a user-selected constraint. For instance, empirical research shows that a dwell duration of 10 to 15 minutes is effective.

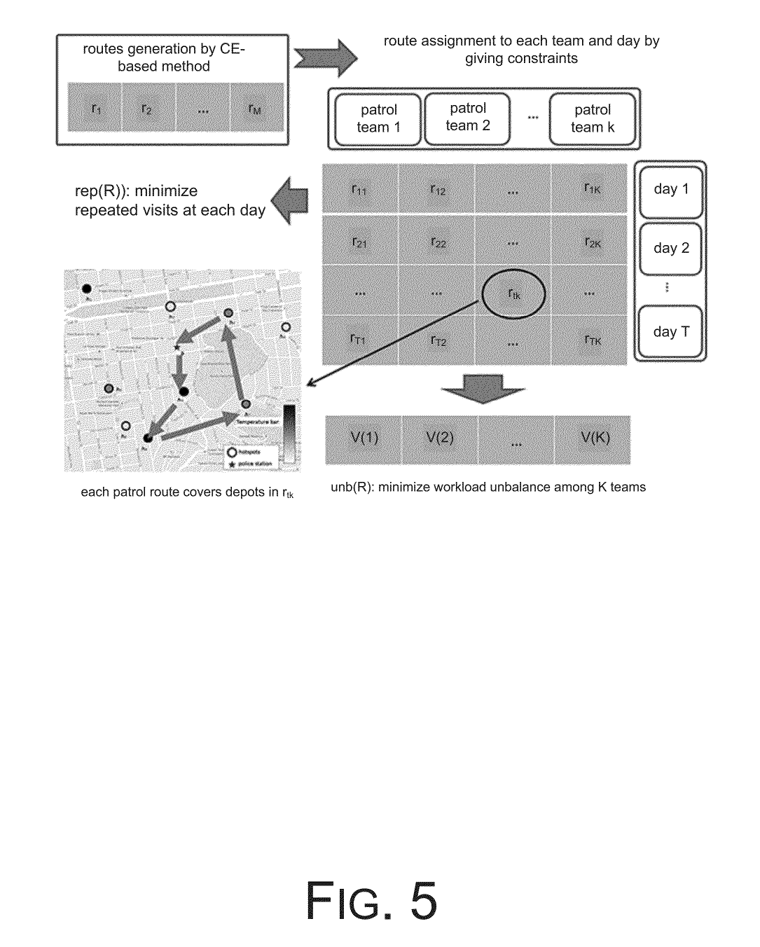

In an implementation, the RAA 120 output includes a schedule that allocates multiple shifts of resources 202 (see FIG. 5) to designated patrol routes. For example, the patrol area may be too large for the staff in the police office to patrol within one shift, and so the patrol task is completed by multiple patrol teams over a period of time (e.g., shifts, days, weeks, months, etc.), with an optimization goal including the minimization of total traffic cost (time, fees, journey distance, etc.).

In some implementations, a patrol mission comprises one patrol route traversed by one patrol team, beginning and ending at the police office. In various examples, a smaller number of total missions is preferred, which is not always coincident with the optimization of total cost, hence a compromise between the optimization goals may be necessary. In some implementations different patrol missions (which usually last for several hours) have route lengths that are as close to each other as possible.

In various implementations, some of the challenges police patrol route planning and allocation may have include: (1) minimizing the total traffic cost over a long time period for multiple patrol teams; (2) minimizing the total number of patrol missions; (3) balancing the burden share among patrol missions; and (4) avoiding repeated visits to any one hotspot during the same mission, and avoiding a revisit by other teams during the same shift. (However, the patrol route design can allow a police car to pass by a hotspot more than once.)

In various implementations, the following definitions may be used with one or more algorithms by the system 100 (via the RAA 120) to optimize resource planning and allocation. The definitions state the police patrol example in more formal terms, but may also be applied analogously to other scenarios.

Assuming K patrol teams, for T (e.g., T=10) days, which forms a set of routes, [symbol] , that are patrolled each in turn by a patrol team. Considering a single patrol route rε [symbol] , and denoting one route among all possible routes being patrolled by the teams;

r=(n₁→n₂→ . . . →n_{N}_{^{r}}),

with depots n₁, n₂, . . . , n_{N}_{^{r}}, and N^{r} being the amount of hotspots visited by route r.

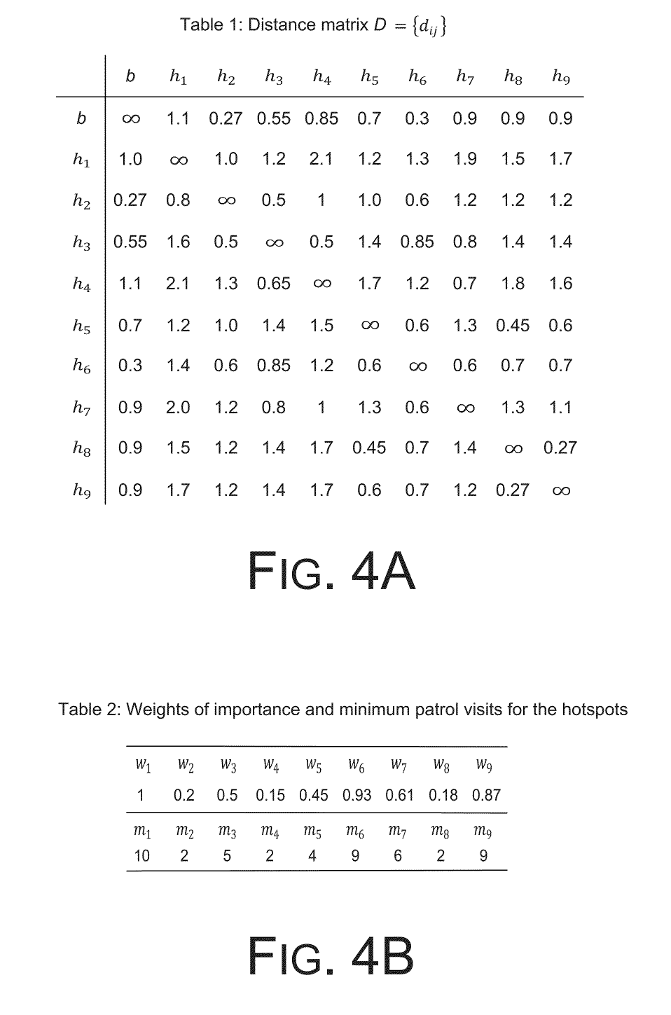

Thus, the minimal constraints, according to the previous analysis, is that:
Constraint 1. Each hotspot h₁ is patrolled (by a patrol team visiting and dwelling for s=10˜15 minutes) for at least mᵢ times during a certain time period T, respectively,
   where mᵢ depends on wᵢ (see Table 2, FIG. 4B). For simplicity, it is assumed that the patrol car travels with a fixed speed v=10 km/h, and that the patrols stay at each target hotspot for s=15 minutes.
Constraint 2. To ensure that the route is a feasible solution to this problem, the route is also subject to that:
   n₁ and n_{N}_{^{r}} are among B, while n₂, . . . , n_{N}_{^{r}}₋₁ belong to [symbol] , (an input defined below).
   There is no sub-circuit, which does not include any node in B, (another input defined below).

According to the above definitions, the total traffic time, (i.e., the cost function) of a patrol route r can be calculated by:

V(r)=Time(r)=t_{1,2}+t_{2,3}+ . . . +t_{N}_{^{r}}_{,1}+cₘ (1)

where cₘ represents the cost of the involvement of one patrol team in the solution. Also, t_{1,2} denotes the traveling time from n₁ to n₂, and so on, while distances between each two depots can be looked up in the distance matrix of FIG. 3.
Constraint 3. The design of r is constrained by working hours S₀ (most often eight hours):

S(r)=V(r)+Nᵣ·s≦S₀

In an implementation, the goal is to find an optimized ∇* such that the traffic time of a single patrol route is minimized, i.e.:

r*= [symbol] V(r) (Goal 1),

subject to Constraints 1, 2 and 3.

Based on the single patrol route planning and allocation above, the multiple route planning scenario is given similarly, with consideration of minimization of the total cost function of all routes.

The T days' time period may be divided into, e.g., t=1, 2, . . . , T time intervals, where the time unit is one day. It is a condition that for each day, considering the allocation of missions among different patrol teams and days, that repeated visits to one hotspot during the same day occur as least frequently as possible.

In an example, the solution is a set of M routes, [symbol] *={rₘ, m=1, 2, . . . , M} assigned to each team and day. Further, C_{g}_{^{t}}_{εr(k)} may be denoted as the repeated visiting times, when all routes rₘ assigned on day t to the team k will visit hotspot n, and C_{g}_{^{t}}_{εr(k)}=0 may be denoted for no visit. Then the restriction may be given by:
Constraint 4. Minimizing the repeat visits:

rep( [symbol] )=Σₜ₌₁^{T}Σₙ₌₁^{T}(Σₖ₌₁^{T}C_{g}_{^{t}}_{εr(k)}−1)

where (•)₊ denotes the positive part of the number, i.e., max(•,0).

The optimization criteria will be the minimization of total traffic time. The first main goal is to find an optimized [symbol] * as follows.

[symbol]

*= [symbol] ( [symbol] V(r)+λrep( [symbol] )) (Goal 2),

subject to the same conditions as Goal 1, where λ is a weighting penalty factor.

In an example, for each r in the obtained plan [symbol] , its total cost function is calculated. In the example, the cost function for each patrol is to be balanced as well as possible. Thus, a measure of the unbalance degree of a patrol load to the other different teams is given by:

unb( [symbol] )=varₖ{πₜ₌₁^{T}V(rₜₖ)}

where rₖ denotes the route for team k and day t, (see FIG. 5).

Similarly this unbalance can be treated as an additional penalty to the cost function:

[symbol]

[symbol]

*= [symbol] ( [symbol] V(r)+Δrep( [symbol] )+ηunb( [symbol] ). (Goal 3),

subject to the same conditions as Goal 1, where λ and eta are weighting penalty factors.

In an implementation, a resource allocation arrangement (RAA) 120 is used with a system 100 to optimize planning and allocation of resources 202, while considering various constraints. To set up the discussion of the arrangement 120, a formal definition of the components of the constrained resource allocation problem is given herein.

For an example, notations of input, intermediate, and output data are given as follows:

Input Data:
The set of originating states of resources 202 (police stations) B=(b), containing B station(s), takes the responsibility for security of the map area in sight.
The set of state [symbol] ={h₁, h₂, . . . , h_{N}} are N states of weights to be assigned with the resources 202.
The (patrol) resources 202 can be divided into K identical parts (teams), each of which may be temporally divided in an arbitrary manner.
Weights of importance and minimum patrol times for the hotspots m; depends on wᵢ.
Distances matrix D (in Table 1 of FIG. 4A) reveals the distance between two arbitrary depots, based on location information, for example, the distance matrix D may be asymmetric.
Cost function based on the above inputs V(•).

Intermediate Data:
M: the number of all routes in the solution set, which may be changed during the optimization due to feasibility.
The possible paths {r₁, r₂, . . . }
Probability matrix of Transition {P=[pᵢⱼ]}, describing the probability of a patrol route from hotspot i to j. {Pᵢⱼ}) is a set of matrices, where for each route r there are N^{r} such matrices. The set of P is given by:

{P(1,1), . . . ,P(1,N^{r}^{₁})}, . . . ,{P(M,1), . . . ,P(M,N^{r}^{_{M}})}

Output Data:

The output of system 100 gives the best possible solution including:
The best routes given by R*={r*₁, r*₂, . . . , r*_{M}}J. For each route r, it gives the 3-tuple sequence (n_{c}, V_{c}, t_{c}), where c is the index inside the sequence.
The assignment matrix of each route to a patrol team and day A=[aₖₘ^{t}], t=1, . . . , T, k=1, . . . , K, m=1, . . . , M, recording all values with aₖₘ^{t}=1 is sufficient. This assignment is implicitly given in the above 3-tuple sequences.
The cost of the proposed solution γ*.

Consider the original Cross Entropy (CE) method for a general optimization [symbol] problem, let [symbol] be the finite set of states (possible routes) for patrol, and let V be a real valued cost function on [symbol] :

V(r*)=γ*= [symbol] V(r)

In the CE method, an estimation problem is associated with the above optimization. For example, define a collection of indicator function {I_{{V(r)≧γ}}} on [symbol] , where γ is the threshold of various values. Let {f (•; ν), νε [symbol] } be a family of probability distribution functions (pdf) on [symbol] with real valued parameter ν.

For a certain uε [symbol] , the above problem is associated with estimating the number:

l(γ)=Pᵤ(V(r)≦γ)=EᵣI_{{V(r)≦γ}}f(r,u)= [symbol] ᵤI_{{V(r)≦γ}}

where Pᵤ is the probability measure and [symbol] ᵤ denotes the corresponding expectation. This new problem is called associated stochastic problem (ASP). Assume γ=γ* and f(•;u) is uniformly distributed on [symbol] , then

l(γ*)=f(r*,u)=1/| [symbol] |

where | [symbol] | denotes the amount of elements [symbol] . Then using likelihood ratio (LR), one can estimate l(γ*) with reference parameter:

$${v}^{*} = {arg min}_{v} { }_{u} {I}_{\{ V ( r ) \leq γ \}} ln f ( r , v )$$

Thus it is estimated by

\hat{ν}*=argmin_{ν}ΣᵢI_{{V(r}_{ᵢ}_{)≦γ}}ln f(rᵢ,ν)

where all rᵢ are generated from pdf f(•; u).

Algorithm 1: Original CE Algorithm for Optimization

| | |
|---|---|
| 1 | define \hat{υ}₀ = u . Set t = 1 |
| 2 | repeat |
| 3 | \| generate a sample R₁, R₂, ••• ,R_{N} from the pdf ƒ(.; υ(t − 1)) and |
| | \| figure out the sample (1 − ρ)-quantile \hat{γ}ₜ of the cost functions |
| 4 | \| use the same sample R₁, R₂, ••• , R_{N} and solve the stochastic |
| | \| program (ASP), with solution denoted by \hat{υ}ₜ. |
| 5 | \| set t = t + 1 |
| 6 | until for t ≧ d(constant, e.g. d = 5), \hat{γ}ₜ = \hat{γ}ₜ₋₁ = ••• = \hat{γ}_{t-d}; |

In various implementations, the RAA 120 uses one or more algorithms to optimize resource allocation. For example, high level descriptions of implementations of these algorithms are illustrated as follows. To begin with, the situation is considered in which there is only one route to be patrolled, so that it is the most classical TSP problem. Goal 1 is solved by Algorithm 2.

Algorithm 2: Sample Route Generation Algorithm

| | |
|---|---|
| 1 | initialize L sample routes [symbol] , c = 0, t₀ = cₘ |
| 2 | for each route r in [symbol] do |
| 3 | \| while t_{c} + t_{c,0} ≦ S₀ , where t_{c,0} is the travelling time from n_{c} to the |
| | \| nearest police station do |
| 4 | \| \| generate the next node n_{c} ∈ {B, [symbol] } according to the transition |
| | matrix P^{k} |
| 5 | \| \| obtain the patrol cost at the node V_{c} = t_{c-1,c} given in (1). |
| 6 | \| \|_ update the patrol arrival time on the node t_{c} = t_{c-1} + V_{c} |
| 7 | \|_calculate the total patrol cost on route as V(r) = Σᵢ₌₀^{c-1} Vᵢ |

First the algorithm of generating a route with the given probability density function (pdf) matrix P may be provided. A route by sequence of depots to be visited may be defined, denoted by 3-tuple (n_{c}, V_{c}, t_{c}: {node, cost, arrival time}), where c is the sequence index.

Algorithm 3: Update of Transition Matrices

| 1 | for n, m ε {1, 2, . . . , N}, k = 1, 2, . . . , N^{r} do | |
|---|---|---|
| 2 | \| update the transition matrices according to | |
| | \| \| \| \| | ${p}_{n m}^{k} = \frac{{Σ}_{l = 1}^{L} {I}_{\{ {V}_{{r}_{i \leq γ}} \}} {I}_{\{ {g}_{n m}^{k} ∈ γ \}}}{{Σ}_{l = 1}^{L} {I}_{\{ {V}_{{r}_{i \leq γ}} \}} {Σ}_{m = 1}^{L} {I}_{\{ {g}_{n m}^{k} ∈ γ \}}}$ |
| 3 | \| smooth the transition matrices according to | |
| | └ | \tilde{p}^{k}ₙₘ = αp^{k}_{nm,i} + (1 − α)\tilde{p}^{k}_{nm,i-1} |

Combining the route generating method, the following CE algorithm (Algorithm 4) is given for finding a single optimal route.

Algorithm 4: CE algorithm for single patrol route planning

| | |
|---|---|
| 1 | initialization: the elite ratio ρ and smoothing update factor α, set the |
| | transition matrices P(1),•••,P(N^{r}) as the uniform distributions, and |
| | iteration index t = 1 |
| 2 | repeat |
| 3 | \| generate L sample routes r₁, r₂, ••• , r_{L} by Algorithm 2 |
| 4 | \| calculate the 1 − ρ quantile \hat{γ}ₜ: order the routes based on a increasing |
| | \| order of the cost V(r), r₍₁₎, r₍₂₎, ••• , r_{(L)}, and set the elite threshold |
| | \hat{γ}ₜ = V(r_{└ρL┘}) |
| 5 | \| update the transition matrices according to Algorithm 3, with γ = \hat{γ}ₜ |
| 6 | \| set iteration t = t + 1 |
| 7 | until for t ≧ d(constant, e.g. d = 5), \hat{γ}ₜ = \hat{γ}ₜ₋₁ = ••• = \hat{γ}_{t-d}; |
| 8 | return the best performing route, i.e. the one with lowest cost |

Referring to FIG. 5, when the multiple patrol route planning is considered, M routes are simultaneously generated and optimized for K patrol teams to be accomplished in T days. Therefore, the solution is a set of routes with corresponding allocation of the routes to each team and day. Goal 2 is merely a transitional goal, hence Goal 3 is directly solved by Algorithm 4. The restriction of equal workload described above is considered in the algorithm as a penalty function. Therefore, the condition is implicitly satisfied by the similar CE algorithm as shown in the following Algorithm 5.

Algorithm 5: CE algorithm for multiple patrol route planning

| | |
|---|---|
| 1 | initialization: set ρ and α, set all the transition matrices for M routes |
| | as the uniform distributions, i.e. {P(1,1), ••• , P(1, N^{r}^{₁})}, ••• , {P(M , |
| | 1), ••• , P(M , N^{r}^{_{M}})} |
| 2 | set iteration index t = 1 |
| 3 | repeat |
| 4 | \| generate L solution candidates routes [symbol] ₁, [symbol] ₂, •••, [symbol] _{L} by |
| | Algorithm 2 applied to each r |
| 5 | \| calculate the 1 − ρ quantile \hat{γ}ₜ = V ( [symbol] _{(└ρL┘)}) |
| 6 | \| update the transition matrices according to Algorithm 3 applied to |
| | each r |
| 7 | \| set iteration t = t + 1 |
| 8 | until for t ≧ d(constant, e.g. d = 5), \hat{γ}ₜ = \hat{γ}ₜ₋₁ = ••• = \hat{γ_{t-d}}; |
| 9 | return the best performing M routes [symbol] * |

In an implementation, the output of the system 100 includes one or more portions of the diagram of multiple patrol route planning shown in FIG. 5. For example, multiple patrol routes are generated by the RAA 120 for multiple patrol teams, over a preselected number of days. Each of the routes corresponds to a portion of the city, including visiting a set number of hotspots, as shown in the diagram. In various implementations, the route planning and location information shown in FIG. 5 may be displayed or otherwise communicated to a police patrol via a mobile device, an in-car computer or communication terminal, or the like. In some implementations, the route information may include mapping information, as shown.

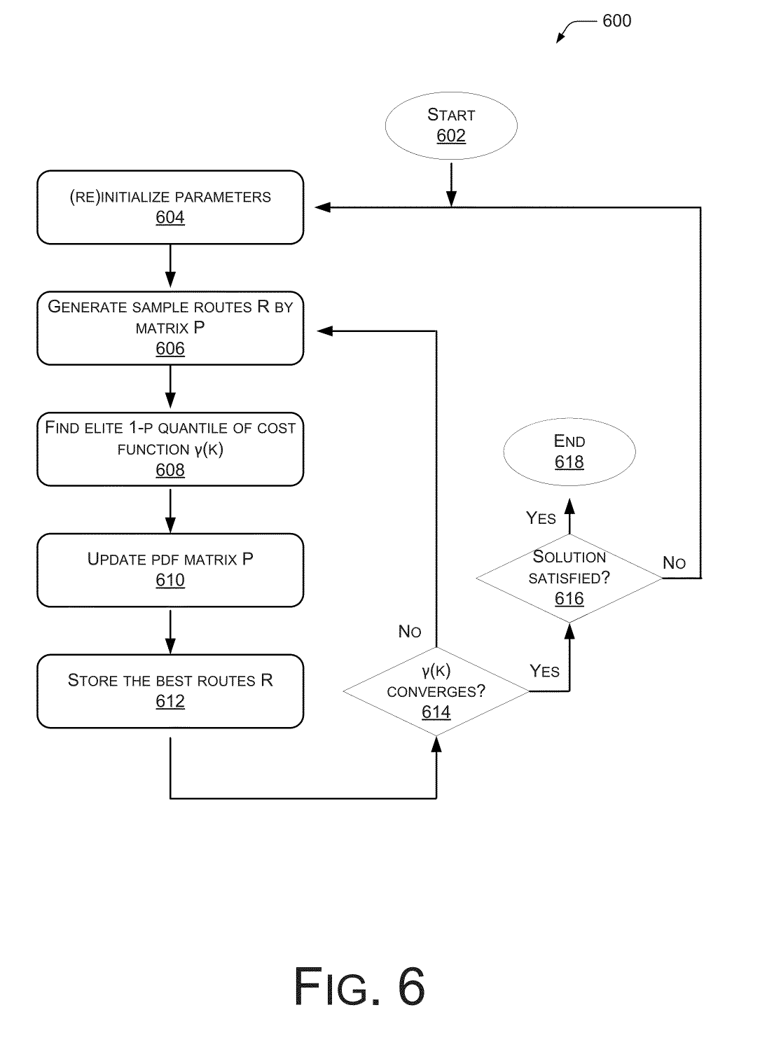

The diagram to show the technique used in Algorithm 5 is illustrated in FIG. 6, and described further below.

In various implementations, the components and modules of the system 100 and/or the resource allocation arrangement 120 may be embodied in hardware and software components. For example, in the implementations, the components and modules may include hardware components residing in the control 102 or processor 106 and/or may include computer executable instructions stored in memory 104 and operable on the processor 106 to perform the functions described.

FIG. 6 is a flow diagram illustrating an example process 600 for optimizing allocation of resources to users, according to an embodiment. For example, the process 600 considers various constraints of the resources while applying one or more algorithms to converge on an optimal allocation. The process 600 is described with reference to FIGS. 1-5.

The order in which the process 600 is described is not intended to be construed as a limitation, and any number of the described process blocks can be combined in any order to implement the process, or alternate processes. Additionally, individual blocks may be deleted from the process without departing from the spirit and scope of the subject matter described herein. Furthermore, the process can be implemented with any suitable components, or combinations thereof, without departing from the scope of the subject matter described herein.

At block 602, the process begins. At block 604, the process includes initializing parameters. In an implementation, the process also includes receiving location information regarding a plurality of resources and a plurality of users. For example, the location information can be received by an input/output component (such as input/output component 108, for example).

In an implementation, the process repeats one or more of the following blocks for a preselected number of iterations or until convergence. In an implementation, convergence comprises less than a predetermined threshold of change of an objective function, after a preset quantity of iterations.

At block 606, the process includes generating a quantity of random travel routes for the plurality of resources to make contact with the plurality of users, based on the location information. In an implementation, this comprises allocating the resources to the users. In an implementation, the process includes generating the quantity of random travel routes for the plurality of resources to make contact with the plurality of users for a preselected duration of time (e.g., for 10 to 15 minutes, for example).

At block 608, the process includes selecting a percentage (e.g., 10%, etc.) of the routes with a lowest cost and ordering the selected routes according to an increasing order of cost. In an implementation, the process includes assigning equal burdens to be shared across the plurality of resources.

At block 610, the process includes updating a probability density function matrix with the selected routes based on the selecting and the ordering. In some implementations, the matrix is output to the users for allocation or route information. At block 612, the process includes storing the best (i.e., the lowest cost) routes in a storage component (such as memory 104 or storage 112, for example) during each iteration.

At block 614, the process includes iteratively converging on a resource allocation solution, including a geo-location of every resource and user and an assignment of resources to each user, wherein the overall cost is minimized and the user load of every resource is substantially balanced. In an implementation, the process includes determining an optimal sequence of resource use by the users, based on a priority of demands for a resource by the users. In an implementation, the process includes optimizing an allocation of the resources to the users via a modified cross entropy technique.

At block 616, the process includes determining whether the solution is satisfied, based on various constraints and preselected goals. If the solution is not satisfied, then the process returns to block 604, for another set of iterations. If the solution is satisfied, then the process continues to block 618. At block 618, the process ends by outputting a route with a lowest cost. In an implementation, the route having the lowest combination of resource cost, transfer cost, and basis cost is selected to be output. In an implementation, the output includes multiple routes optimized for multiple resources and multiple users. In one implementation, the output is displayed on a mobile device or a computer/communications terminal to relay the route information to the users.

In alternate implementations, other techniques may be included in the process 600 in various combinations, and remain within the scope of the disclosure.

Portions of the subject matter of this disclosure can be implemented as a system, method, apparatus, or article of manufacture using standard programming and/or engineering techniques to produce software, firmware, hardware or any combination thereof to control a computer or processor (such as processor 106, for example) to implement the disclosure. For example, portions of an example system 100 may be implemented using any form of computer-readable media (shown as memory 104 in FIG. 1, for example) that is accessible by the processor 106. Computer-readable media may include, for example, computer storage media and communications media.

Computer-readable storage media includes volatile and nonvolatile, removable and non-removable media implemented in any method or technology for storage of information such as computer-readable instructions, data structures, program modules or other data. Memory 104 is an example of computer-readable storage media. Storage 112, which may comprise local, network, or cloud storage, for example, is another example of computer-readable storage media. Additional types of computer-readable storage media that may be present include, but are not limited to, RAM, ROM, EEPROM, flash memory or other memory technology, CD-ROM, digital versatile disks (DVD) or other optical storage, magnetic disks or other magnetic storage devices, or any other medium which may be used to store the desired information and which may accessed by the processor 106.

In contrast, communication media typically embodies computer readable instructions, data structures, program modules, or other data in a modulated data signal, such as a carrier wave, or other transport mechanism.

While the subject matter has been described above in the general context of computer-executable instructions of a computer program that runs on a computer and/or computers, those skilled in the art will recognize that the subject matter also may be implemented in combination with other program modules. Generally, program modules include routines, programs, components, data structures, and the like, which perform particular tasks and/or implement particular abstract data types.

Moreover, those skilled in the art will appreciate that the innovative techniques can be practiced with other computer system configurations, including single-processor or multiprocessor computer systems, mini-computing devices, mainframe computers, as well as personal computers, hand-held computing devices, microprocessor-based or programmable consumer or industrial electronics, and the like. The illustrated aspects may also be practiced in distributed computing environments where tasks are performed by remote processing devices that are linked through a communications network. However, some, if not all aspects of the disclosure can be practiced on stand-alone computers. In a distributed computing environment, program modules may be located in both local and remote memory storage devices.

Although implementations have been described in language specific to structural features and/or methodological acts, it is to be understood that the subject matter defined in the appended claims is not necessarily limited to the specific features or acts described above. Rather, the specific features and acts are disclosed as illustrative forms of illustrative implementations. For example, the methodological acts need not be performed in the order or combinations described herein, and may be performed in any combination of one or more acts.

What is claimed is:

1. Non-transitory computer-readable storage media having computer-executable instructions stored thereon, that when executed, cause a computer processor to initiate a process, comprising:
receiving location information regarding a plurality of police patrol teams and a plurality of hotspots;
repeating, for a preselected number of iterations or until convergence:
generating, based on the location information, a quantity of random patrol routes for the plurality of police patrol teams to make visits at the plurality of hotspots;
selecting a percentage of the routes with a lowest cost and ordering the selected routes according to an increasing order of cost;
assigning equal patrol route and hotspot burdens to each of the patrol teams; and
updating a probability density function matrix with the selected routes based on the selecting and the ordering; and
outputting optimized patrol routes having a lowest cost to the patrol teams for execution.

2. The computer readable storage media of claim 1, further comprising receiving traffic condition information, and selecting the routes based on distances of the routes and the traffic condition information.

3. A system, comprising:
a processor;
a memory hardware device communicatively coupled to the processor;
a resource allocation arrangement stored in the memory hardware device and operative on the processor to:
receive location information regarding a plurality of resources and a plurality of users;
repeat, for a preselected number of iterations or until convergence:
generate, based on the location information, a quantity of random travel routes for the plurality of resources to make contact with the plurality of users;
select a percentage of the routes with a lowest cost and ordering the selected routes according to an increasing order of cost; and
update a probability density function matrix with the selected routes based on the selecting and the ordering; and
output a route with a lowest cost.

4. The system of claim 3, further comprising an input/output component arranged to receive location information regarding the plurality of resources and the plurality of users, the location information used to determine distances from the resources to the users.

5. The system of claim 4, wherein the input/output component is arranged to output route information in a map-based format.

6. The system of claim 3, wherein the system is arranged to schedule police patrols at preselected locations within a portion of a city for a plurality of patrol teams, such that each of a set of event spots within the city is visited at least once by a patrol team and such that a load of each of the patrol teams is substantially balanced.

7. The system of claim 6, wherein the system is arranged to avoid repeated visits to any one event spot during a same patrol mission, and to avoid a revisit to the event spot by other patrol teams during a same shift.

8. The system of claim 6, wherein the system is arranged to minimize a total traffic cost over a time period for multiple patrol teams, minimize a total number of patrol missions, and balance a patrol mission burden share among all patrol missions.

9. The system of claim 6, wherein the system is arranged to schedule for certain event spots to be visited by a patrol team during specific time periods.

10. The system of claim 6, wherein the system is arranged with multiple police depots having a quantity of policemen starting patrol from each depot, and wherein a policeman can return to any depot, while maintaining a fixed quantity of policemen to be located at each depot after all patrols are finished.

11. The system of claim 10, wherein the quantity of policemen starting patrol from each depot or to be located at each depot after all patrols are finished is undetermined and has an upper bound, and the usage of each policeman has a fixed cost, with a total cost being minimized by the system.

12. A method, comprising:
receiving location information regarding a plurality of resources and a plurality of users;
repeating, for a preselected number of iterations or until convergence:
generating, based on the location information, a quantity of random travel routes for the plurality of resources to make contact with the plurality of users;
selecting a percentage of the routes with a lowest cost and ordering the selected routes according to an increasing order of cost; and
updating a probability density function matrix with the selected routes based on the selecting and the ordering; and
outputting a route with a lowest cost.

13. The method of claim 12, further comprising generating the quantity of random travel routes for the plurality of resources to make contact with the plurality of users for a preselected duration of time.

14. The method of claim 12, further comprising storing the lowest cost routes during each iteration.

15. The method of claim 12, further comprising assigning equal burdens to be shared across the plurality of resources.

16. The method of claim 12, further comprising determining an optimal sequence of resource use by the users, based on a priority of demands for a resource by the users.

17. The method of claim 12, further comprising optimizing an allocation of the resources to the users via a modified cross entropy technique.

18. The method of claim 12, further comprising iteratively converging on a resource allocation solution, including a geo-location of every resource and user and an assignment of resources to each user, wherein the overall cost is minimized and the user load of every resource is substantially balanced.

19. The method of claim 12, wherein the route having the lowest combination of resource cost, transfer cost, and basis cost is selected to be output.

20. The method of claim 12, wherein convergence comprises less than a predetermined threshold of change of an objective function, after a preset quantity of iterations.
